(19) United States
(12) Patent Application Publication
(10) Pub. No.: US 2025/0335241 A1
(43) Pub. Date: Oct. 30, 2025

(54) SYSTEM FOR RESTRUCTURING MULTI-THREADED OPERATIONS

(71) Applicant: T-Mobile USA, Inc., Bellevue, WA (US)

(72) Inventor: David B. Moffett, Issaquah, WA (US)

(21) Appl. No.: 18/651,504

(22) Filed: Apr. 30, 2024

(51) Int. Cl. G06F 9/48; G06F 9/50

(52) U.S. Cl. CPC G06F 9/4881; G06F 9/5061; G06F 2209/5021

(57) ABSTRACT

The system can receive a request to perform multiple operations on multiple threads of the processor. An operation is a structured set of tasks used to perform a specific computation required to execute the requested process. The system can analyze the multiple operations to determine a type of operation or dependency on other operations. The system can categorize the multiple operations based on the analysis. The system can divide each operation into at least one task and generate a queue of tasks. The queue of tasks contains the tasks for each of the multiple operations. Generating the queue of tasks converts the multiple operations from a multi-threaded process to a single-threaded process. The system can execute, on a single thread of the processor, the queue of tasks and output a result for each task executed in the queue of tasks.

### BACKGROUND

A queue is a collection of entities that are maintained in a sequence and can be modified by the addition of entities at one end of the sequence and the removal of entities from the other end of the sequence. By convention, the end of the sequence at which elements are added is called the back, tail, or rear of the queue, and the end at which elements are removed is called the head or front of the queue, analogously to the words used when people line up to wait for goods or services. The operation of adding an element to the rear of the queue is known as enqueue, and the operation of removing an element from the front is known as dequeue. Other operations may also be allowed, often including a peek or front operation that returns the value of the next element to be dequeued without dequeuing it.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates an embodiment of multiple operations divided into multiple tasks.

FIG. 3a is a block diagram that illustrates an embodiment of an operation to authenticate a user.

FIG. 3b is a block diagram that illustrates an embodiment of both a successful and a failed user authentication.

FIG. 4 is a flowchart that illustrates a process for restructuring multi-threaded processes.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a system for restructuring complex processes to run on a single processor thread. In one embodiment, the system can receive a request to perform multiple operations as a multi-threaded process or coroutine. For example, a multi-threaded process is a process of concurrently executing an operation on multiple processor threads. The operation can be run in parallel or concurrently to increase the process's efficiency. An operation can be a structured set of tasks used to perform a specific computation or process. A computation or process can be performed using multiple operations. In one embodiment, the operation can have multiple dependencies. A dependency can include a given operation being dependent on the multiple operations and/or the multiple operations being dependent on the given operation.

The system can analyze the multiple operations to determine the type of operation and the dependencies of the operation. A type of operation can include the purpose or function of the operation. For example, a type of operation can include an authentication request or an access token request. The system can categorize the multiple operations based on the operation type or the operation's dependency. For example, an operation can be placed in a single category based solely on operation type or dependency, or the operation can be placed into multiple categories based on the operation's type or dependency.

The system can divide each operation into at least one task. A task can be the smallest unit an operation can be divided into. For example, a task can be a single step with two outcomes: success or failure. The system can queue the tasks for each operation. For example, a single queue containing the tasks for each of the multiple operations can be generated. The tasks can be queued based on dependency or on the order in which the task is placed into the queue. In one embodiment, each task is queued based on a priority rating. For example, the system can assign a priority rating to the task based on the importance of the task in the operation. The priority can be determined based on the number of dependencies for the task and/or the number of dependencies for the operation. In one embodiment, repeated tasks are removed from the queue to increase the operation's efficiency.

Generating the queue of tasks can convert the multi-threaded process into a single-threaded process. For example, the system can modify the multiple operations to force each operation to run on a single thread instead of the multiple threads the operation was coded to run on. Performing the tasks on a single thread can minimize issues caused by multi-threading and coroutines. For example, a single-thread process can minimize race conditions, deadlocks, and concurrent modification issues. For example, race conditions can occur when multiple threads or processes access the same data concurrently, which can lead to the final result changing depending on the order in which the threads or processes were executed. Race conditions can result in unpredictable behavior, data corruption, or crashes for the operation. For example, deadlocks can occur when two or more threads or processes are blocked, waiting for the other to release a resource, allowing neither thread nor process to proceed. Deadlock can result in the operation hanging or crashing. The issues can be minimized due to the defined boundaries of the tasks caused by the controlled and predictable nature of executing the tasks in the queue. Additionally, queuing the tasks can facilitate orderly processing and dependency management.

The system can execute the queue of tasks. For example, the tasks can be executed in the order in which the tasks were queued. The system can output a result for each task. For example, the result outputted can be either an indication of success or failure of the task. In one embodiment, a failed task alert can be generated when a failure occurs. The system can analyze the failed task alert to determine how the failure affects other tasks. Based on the analysis, the system can end the operation when the failure of the task causes a failure of the operation.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

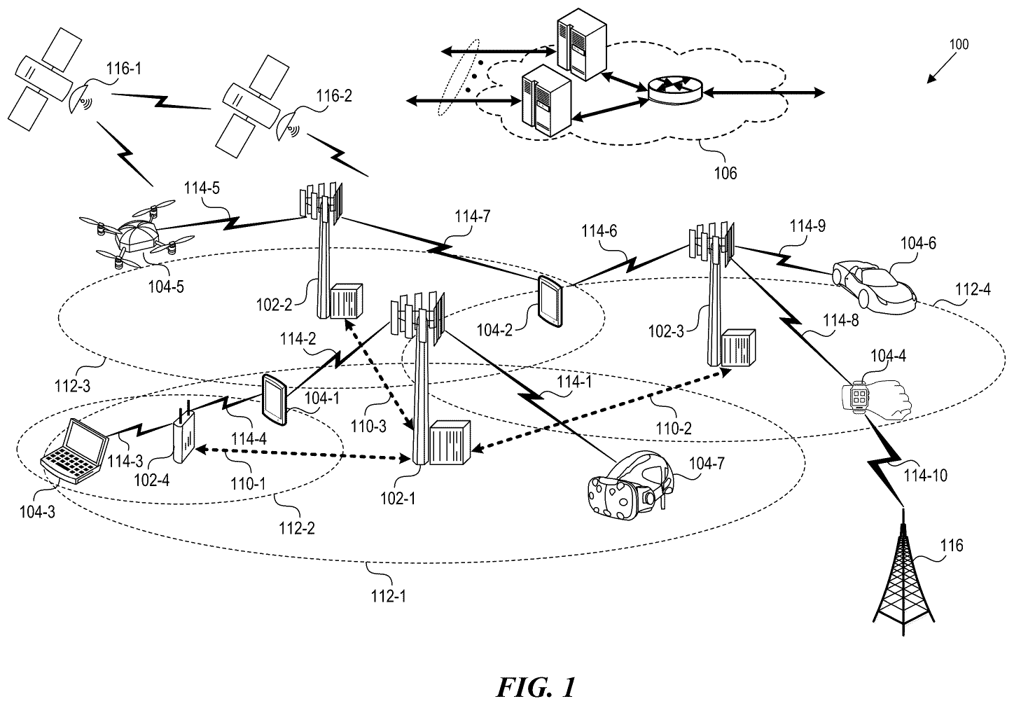

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Multi-Threaded Operation Restructuring System

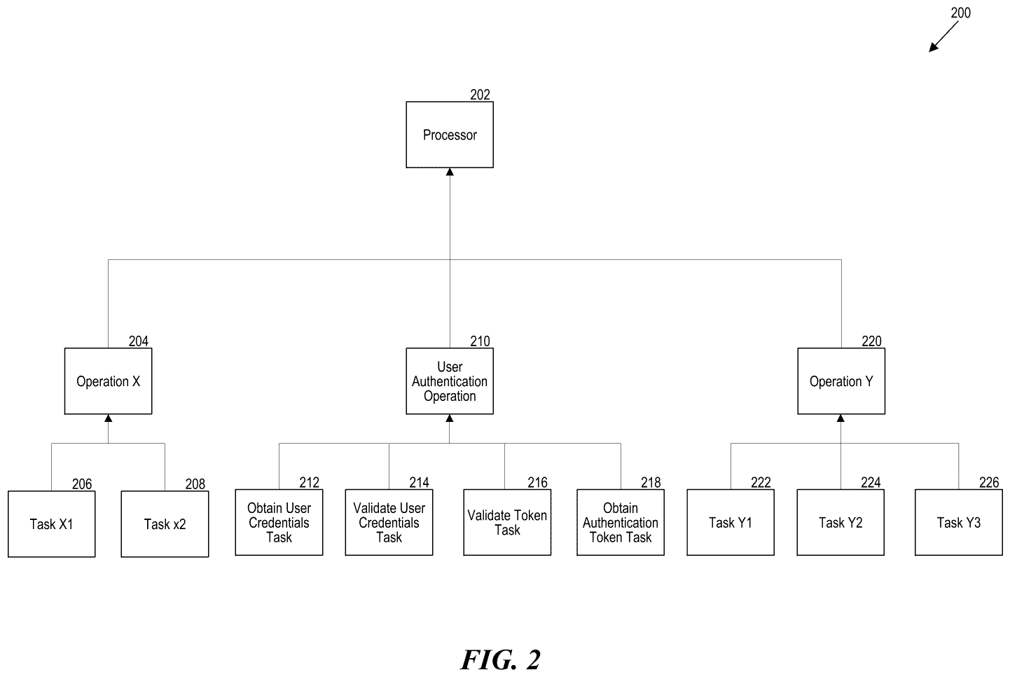

FIG. 2 is a block diagram that illustrates an embodiment 200 of multiple operations divided into multiple tasks. A processor 202 can be configured to execute multiple operations. The processor 202 can retrieve operations from a queue and execute the operations in the order that the operations are added to the queue. The processor 202 can run in a dedicated background thread or coroutine to offload operations from other processing.

An operation is a structured set of tasks used to perform a specific computation or process. The operation can encapsulate all the necessary steps and dependencies required to perform and complete the computation or process. For example, the multiple operations can include operation X 204, operation Y 220, and/or a user authentication operation 210. Operation X 204 can be divided into two tasks. Operation Y 220 can be divided into three tasks. The user authentication operation 210 can be divided into four tasks.

A task is the smallest unit of work or step within an operation. A task can perform a specific function and return a status for the task. The status can indicate either a successful execution of the task or a failed execution of the task. In one embodiment, the tasks divided from the operation can be executed sequentially, where each task's execution is potentially dependent on the success of a previous task. For example, operation X 204 can be divided into task X1 206 and task X2 208. The outcome of task X1 206 and task X2 208 can be either a success or a failure. In one embodiment, task X2 208 is not executed until an indication is received that task X1 206 was successfully executed.

For example, operation Y 220 can be divided into task Y1 222, task Y2 224, and task Y3 226. The outcome of task Y1 222, task Y2 224, and task Y3 226 can be either a success or a failure. In one example, task Y1 222 can be dependent on task Y2 224, and task Y3 226 can be dependent on task Y2 224. Task Y2 224 must therefore be successfully executed before either task Y1 222 or task Y3 226 can be executed. In another example, task Y2 224 is dependent on task Y3 226, and task Y1 222 is not dependent on any task. Task Y3 226 must therefore be successfully executed before task Y2 224, but task Y1 222 can be executed before, in between, or after task Y2 224 and task Y3 226.

For example, the user authentication operation 210 can be executed to authenticate a user. The user authentication operation 210 can be divided into an obtain user credentials task 212, a validate user credentials task 214, a validate token task 216, and an obtain authentication token task 218. In one example, the validate user credentials task 214 can be dependent on the obtain user credentials task 212. The validate token task 216 can be dependent on both the validate token task 216 and the obtain authentication token task 218. The obtain authentication token task 218 can be dependent on the validate token task 216. Therefore, based on the dependencies, the tasks must be executed in the following order: an obtain user credentials task 212, a validate user credentials task 214, a validate token task 216, and an obtain authentication token task 218.

The tasks from each operation can be placed in a queue. The queue contains the operations awaiting execution by the processor. The operations and tasks can be added to the queue at any time. In one example, the operations and tasks can be executed in the order the operations and tasks were added to the queue. In another example, the operations and tasks are executed based on a determined priority. The priority can be based on the dependency of the operation and task or an assigned importance or priority value.

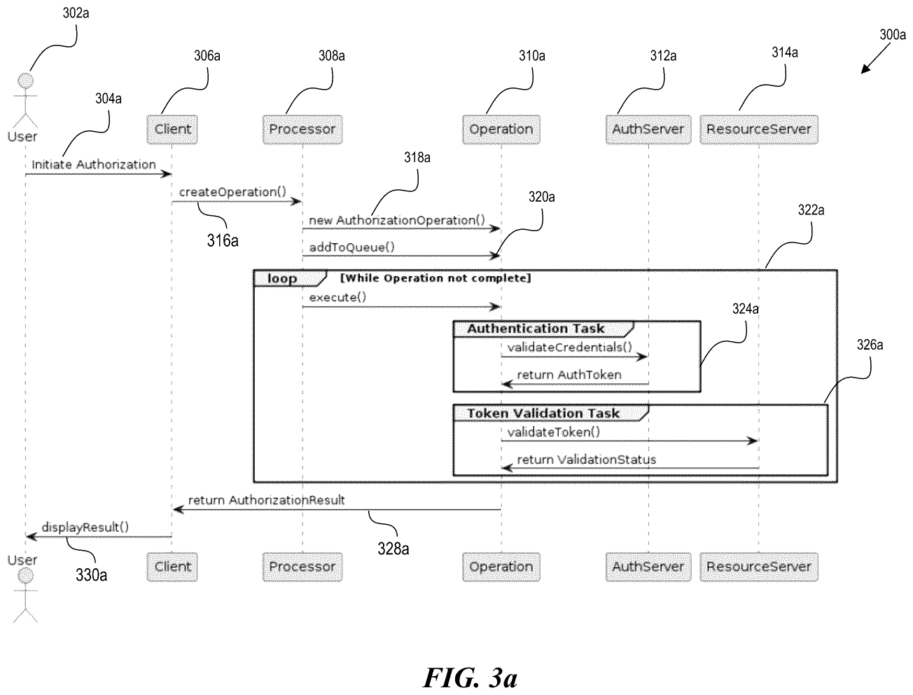

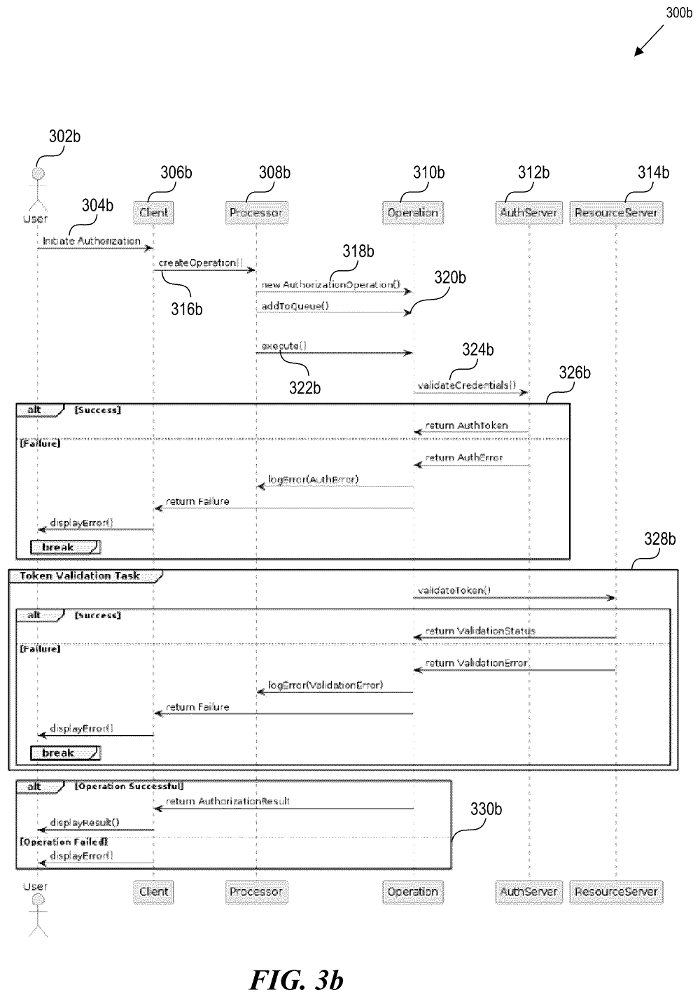

FIG. 3a is a block diagram that illustrates an embodiment 300a of an operation to authenticate a user 302a. User authentication can include multiple steps, each of which can be a single task the system must complete to authenticate the user 302a. When the system receives an operation request to authenticate a user 302a, the system can divide the operation into individual tasks.

The user 302a can initiate an authorization 304a at the client 306a. The client 306a can create an operation 316a and send the created operation 316a to the processor 308a. The new authorization operation 318a is added to the queue 320a. The new authorization operation 318a added to the queue 320a can become operation 310a. Operation 310a can be divided into multiple tasks 322a. Each of the multiple tasks 322a with the operation 310a performs a single network call and returns either a success or a failure status. In one embodiment, the single network call is performed over a telecommunications network.

The authentication task 324a can include three tasks, each of which can be either a success or a failure. During task one, the system can receive the credentials of user 302a. Task two will not be executed until task one is successfully completed. During task two, the system can validate the user credentials at the authentication server 312a. In one embodiment, the user credentials are validated using a telecommunications network such as a 5G network. Task three will not be executed until task two is successfully completed. During task three, the system can return an authentication token over the telecommunications network from the authentication server 312a to the operation 310a. When task three is successfully completed, task four, the token validation task 326a, can be executed. At the token validation task 326a, the system can validate the authentication token at the resource server 314a. The resource server 314a can return, over the telecommunications network, the validation status of the token to the operation 310a as either a success or a failure. The operation 310a can return the authorization result 328a to the client 306a. The client 306a can display the result 330a to the user 302a.

To handle errors caused by a task failure, in one embodiment, the operation can be designed to stop the execution of tasks and generate an alert when an error occurs. In another embodiment, the system can attempt alternative or subsequent tasks to complete the operation when a failed task occurs. In another embodiment, the system can include a retry mechanism to log errors and failures and re-execute failed tasks. For example, the system can continuously re-execute the task until the task is successfully completed, or the system can re-execute the task a predetermined number of times or for a predetermined time period.

FIG. 3b is a block diagram that illustrates an embodiment 300b of both a successful and a failed user authentication. Similarly described above in FIG. 3a, user authentication can include multiple tasks that need to be completed to authenticate the user 302b. The system can divide the authentication request operation into individual tasks.

The user 302b can initiate an authorization 304b at the client 306b. The client 306b can create an operation 316b and send the created operation 316b to the processor 308b. The new authorization operation 318b can be added to the queue 320b. The new authorization operation 318b can become operation 310b. The processor can cause the execution 322b of the operation 310b. The operation 310b can be divided into multiple tasks. The multiple tasks of the operation 310b can return either a success or a failure status.

For example, the authorization request can include four distinct tasks. During task one, the system can receive user credentials from the user 302b. Task two can be executed once task one is successfully completed. When task one is not successfully completed, the system can end the operation and return an error code. During task two, the system can validate the credentials 324b at the authentication server 312b. When task two is not successfully completed, the system can end the operation and return an error code. Task three 326b can be executed once task two is successfully completed. During task three 326b, the system can return an authentication token to the operation 310b from the authentication server 312b. When a failure occurs during task three, the authentication server 312b can return an authentication error to the operation 310b. The operation 310b can cause the processor 308b to log the authentication error. The processor 308b can return the failure to the client 306b. The client 306b can display the error to the user 302b. The system can end the operation after displaying the error to the user 302b.

Task four 328b can be executed once task three is successfully completed. During task four 328b, the token validation task can occur. The operation 310b can validate the token at the resource server 314b. When task four 328b is successful, the resource server 314b can return the validation status to the operation 310b. When task four 328b fails, the resource server can return a validation error to the operation 310b. The operation 310b can cause the processor 308b to log the authentication error. The processor 308b can return the failure to the client 306b. The client 306b can display the error to the user 302b. The system can end the operation after displaying the error to the user 302b.

When every task of the operation has been executed, the authorization result 330b can be returned from the operation 310b to the client 306b. When the operation is a success, the client 306b can indicate the success to the user 302b. When the operation failed, the client 306b can display the error and failure to the user 302b. Executing the operation in this manner ensures API safety by encapsulating the logic of each task within defined boundaries and by managing the execution flow through the operation and processor components. Additionally, this can prevent erroneous calls and ensures that each step in a computation is executed as intended.

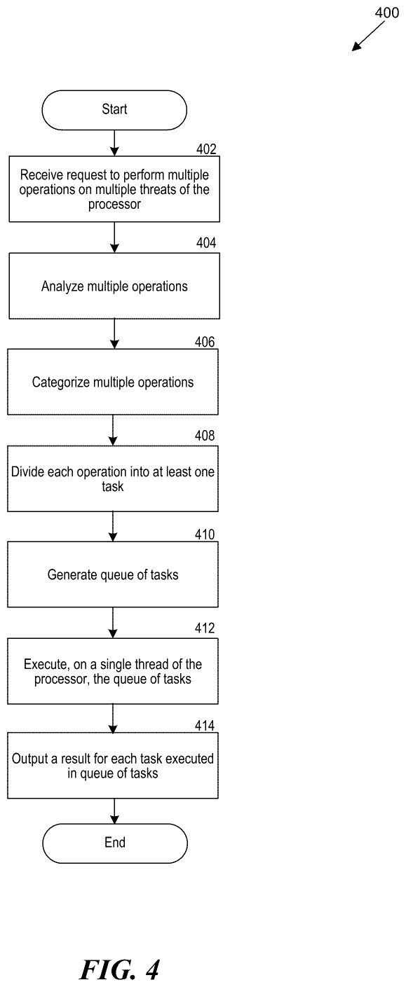

FIG. 4 is a flowchart that illustrates a process 400 for restructuring multi-threaded processes. The process can be performed by a system. In one example, the system includes at least one hardware processor and at least one non-transitory memory storing instructions, which, when executed by at least one hardware processor, cause the system to perform the process 400.

At step 402, the system can receive a request to perform multiple operations on multiple threads of the processor to perform a requested process. The request to perform the multiple operations on multiple threads of the processor causes the multiple operations to be run concurrently. An operation is a structured set of tasks used to perform a specific computation required to execute the requested process and includes multiple dependencies.

At step 404, the system can analyze the multiple operations. The analysis can determine a type of operation or dependency of an operation on other operations. At step 406, the system can categorize the multiple operations based on operation type or dependency on other operations. At step 408, the system can divide each operation into at least one task. The outcome of the task can either be a success or a failure.

At step 410, the system can generate a queue of tasks. The queue of tasks contains the tasks for each of the multiple operations and generating the queue of tasks converts the multiple operations from a multi-threaded process to a single-threaded process. The tasks are queued sequentially according to the multiple dependencies. In one example, the system can remove repeated tasks from the queue of tasks. In another example, the system can assign a priority to each task contained in the queue of tasks. The priority of the tasks is determined by the order the task was inputted into the queue, a dependency of the task, or a predetermined priority rating.

At step 412, the system can execute, on a single thread of the processor, the queue of tasks in the sequential order of the queue. In one example, the system can convert the multiple operations coded to run on the multiple threads of the processor to run on a single thread of the processor. Converting the multiple operations to run on a single thread of the processor minimizes race conditions and concurrent modification issues.

At step 414, the system can output a result for each task executed in the queue of tasks, where the result represents either a success or a failure of the execution of the task. In one example, the system can receive a failed task alert and can analyze the failed task alert to determine that failure affects at least one other task. The system can end the operation based on the failed task alert when a failure of the task causes a failure of the operation.

In one example, the system, when executing the queue of tasks to authenticate a user, can receive an operation request to authenticate the user. The system can divide the operation into multiple tasks. The multiple tasks include receiving a user credential, validating the user credential, obtaining an authentication token, validating the authentication token, and authenticating the user. The system can queue the multiple tasks based on a dependency of the tasks. The system can execute the multiple tasks, wherein executing the multiple tasks causes the instructions to further cause the system to receive the user credential. The user credential can include a username or password for the user. The system can validate the user credential with an authentication server, where a failure to validate the user credential notifies the user of the failure and ends the operation. The system can obtain, based on a successful validation of the user credential, the authentication token from the authentication server. The system can validate the authentication token with a resource server. A failure to validate the authentication token with the resource server notifies the user of the failure and ends the operation. The system can authenticate the user, based on a successful execution of each task.

In one example, the system, when executing the queue of tasks, causes a user to receive an access token and can receive an operation request to receive the access token. The access token stores security information and allows the user to access a process or application. The system can divide the operation into multiple tasks. The multiple tasks include receiving a request for the access token, connecting to an authentication server, receiving a time code, receiving the access token, and saving the access token. The system can queue the multiple tasks based on a dependency of the tasks. The system can execute the multiple tasks, wherein executing the multiple tasks causes the instructions to further cause the system to receive a request for the access token from a user device. The system can determine a connection to the authentication server over a communication network. The system can receive a time code from the authentication server, where a failure to validate the time code of the authentication server against the user device ends the operation. The system can receive the access token from the authentication server and can save the access token to the user device.

### Computer System

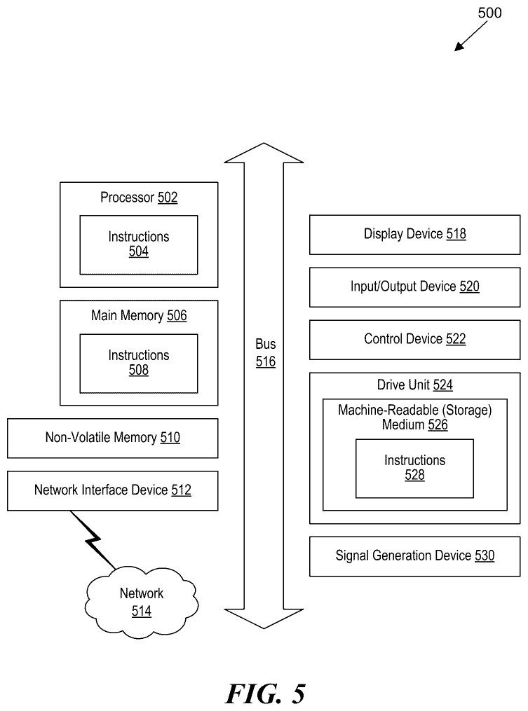

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system comprising:
at least one hardware processor; and
at least one non-transitory memory storing instructions, which, when executed by the at least one hardware processor, cause the system to:
receive a request to perform multiple operations on multiple threads of the processor to perform a requested process,
wherein the request to perform the multiple operations on multiple threads of the processor causes the multiple operations to be run concurrently,
wherein an operation is a structured set of tasks used to perform a specific computation required to execute the requested process, and
wherein an operation includes multiple dependencies;
analyze the multiple operations,
wherein analyzing the multiple operations determines a type of operation or dependency of an operation on other operations;
categorize the multiple operations based on operation type or dependency on other operations;
divide each operation into at least one task,
wherein an outcome of the at least one task can either be a success or a failure;
generate a queue of tasks,
wherein the queue of tasks contains the tasks for each of the multiple operations,
wherein generating the queue of tasks converts the multiple operations from a multi-threaded process to a single-threaded process, and
wherein the tasks are queued sequentially according to the multiple dependencies;
execute, on a single thread of the processor, the queue of tasks based on the multiple dependencies; and
output a result for each task executed in the queue of tasks,
wherein the result represents either a success or a failure of the execution of the at least one task.

2. The system of claim 1 further caused to:
receive a failed task alert;
analyze the failed task alert to determine that failure affects at least one other task; and
end the operation based on the failed task alert when the failure of the task causes a failure of the operation.

3. The system of claim 1 further caused to:
remove repeated tasks from the queue of tasks.

4. The system of claim 1 further caused to:
assign a priority to each task contained in the queue of tasks,
wherein the priority of the at least one task is determined by what order the at least one task was inputted into the queue, a dependency of the at least one task, or a predetermined priority rating.

5. The system of claim 1, wherein executing the queue of tasks authenticates a user, further caused to:
receive an operation request to authenticate the user;
divide the operation into multiple tasks,
wherein the multiple tasks include receiving a user credential, validating the user credential, obtaining an authentication token, validating the authentication token, and authenticating the user;
queue the multiple tasks based on a dependency of the tasks; and
execute the multiple tasks, wherein executing the multiple tasks causes the instructions to further cause the system to:
receive the user credential,
wherein the user credential includes a username or password for the user;
validate the user credential with an authentication server,
wherein a failure to validate the user credential notifies the user of the failure and ends the operation;
obtain, based on a successful validation of the user credential, the authentication token from the authentication server;
validate the authentication token with a resource server,
wherein a failure to validate the authentication token with the resource server notifies the user of the failure and ends the operation; and
authenticate the user, based on a successful execution of each task.

6. The system of claim 1, wherein executing the queue of tasks causes a user to receive an access token, further caused to:
receive an operation request to receive the access token,
wherein the access token stores security information and allows the user to access a process or application;
divide the operation into multiple tasks,
wherein the multiple tasks include receiving a request for the access token, connecting to an authentication server, receiving a time code, receiving the access token, and saving the access token;
queue the multiple tasks based on a dependency of the tasks; and
execute the multiple tasks, wherein executing the multiple tasks causes the instructions to further cause the system to:
receive the request for the access token from a user device;
determine a connection to the authentication server over a communication network;
receive a time code from the authentication server,
wherein a failure to validate the time code of the authentication server against the user device ends the operation;
receive the access token from the authentication server; and
save the access token to the user device.

7. The system of claim 1 further caused to:
convert the multiple operations coded to run on the multiple threads of the processor to run on the single thread of the processor,
wherein converting the multiple operations to run on the single thread of the processor minimizes race conditions and concurrent modification issues.

8. A non-transitory, computer-readable storage medium comprising instructions recorded thereon, wherein the instructions, when executed by at least one data processor of a system, cause the system to:
receive a request to perform multiple operations on multiple threads of the processor to perform a requested process,
wherein the request to perform the multiple operations on multiple threads of the processor causes the multiple operations to be run concurrently,
wherein an operation is a structured set of tasks used to perform a specific computation required to execute the requested process, and
wherein an operation includes multiple dependencies;
analyze the multiple operations,
wherein analyzing the multiple operations determines a type of operation or dependency of an operation on other operations;
categorize the multiple operations based on operation type or dependency on other operations;
divide each operation into at least one task,
wherein an outcome of the at least one task can either be a success or a failure;
generate a queue of tasks,
wherein the queue of tasks contains the tasks for each of the multiple operations,
wherein generating the queue of tasks converts the multiple operations from a multi-threaded process to a single-threaded process, and
wherein the tasks are queued sequentially according to the multiple dependencies;
execute, on a single thread of the processor, the queue of tasks based on the multiple dependencies; and
output a result for each task executed in the queue of tasks,
wherein the result represents either a success or a failure of the execution of the at least one task.

9. The non-transitory, computer-readable storage medium of claim 8 further caused to:
receive a failed task alert;
analyze the failed task alert to determine that failure affects at least one other task; and
end the operation based on the failed task alert when the failure of the execution of the at least one task causes a failure of the operation.

10. The non-transitory, computer-readable storage medium of claim 8 further caused to:
remove repeated tasks from the queue of tasks.

11. The non-transitory, computer-readable storage medium of claim 8 further caused to:
assign a priority to each task contained in the queue of tasks,
wherein the priority of the at least one task is determined by what order the at least one task was inputted into the queue, a dependency of the task, or a predetermined priority rating.

12. The non-transitory, computer-readable storage medium of claim 8, wherein executing the queue of tasks authenticates a user, further caused to:
receive an operation request to authenticate the user;
divide the operation into multiple tasks,
wherein the multiple tasks include receiving a user credential, validating the user credential, obtaining an authentication token, validating the authentication token, and authenticating the user;
queue the multiple tasks based on a dependency of the tasks; and
execute the multiple tasks, wherein executing the multiple tasks causes the instructions to further cause the system to:
receive the user credential,
wherein the user credential includes a username or password for the user;
validate the user credential with an authentication server,
wherein a failure to validate the user credential notifies the user of the failure and ends the operation;
obtain, based on a successful validation of the user credential, the authentication token from the authentication server;
validate the authentication token with a resource server,
wherein a failure to validate the authentication token with the resource server notifies the user of the failure and ends the operation; and
authenticate the user, based on a successful execution of each task.

13. The non-transitory, computer-readable storage medium of claim 8, wherein executing the queue of tasks causes a user to receive an access token, further caused to:
receive an operation request to receive the access token,
wherein the access token stores security information and allows the user to access a process or application;
divide the operation into multiple tasks,
wherein the multiple tasks include receiving a request for the access token, connecting to an authentication server, receiving a time code, receiving the access token, and saving the access token;
queue the multiple tasks based on a dependency of the tasks; and
execute the multiple tasks, wherein executing the multiple tasks causes the instructions to further cause the system to:
receive the request for the access token from a user device;
determine a connection to the authentication server over a communication network;
receive a time code from the authentication server,
wherein a failure to validate the time code of the authentication server against the user device ends the operation;
receive the access token from the authentication server; and
save the access token to the user device.

14. The non-transitory, computer-readable storage medium of claim 8 further caused to:
convert the multiple operations coded to run on the multiple threads of the processor to run on the single thread of the processor,
wherein converting the multiple operations to run on the single thread of the processor minimizes race conditions and concurrent modification issues.

15. A method comprising:
receiving a request to perform multiple operations on multiple threads of a processor to perform a requested process,
wherein the request to perform the multiple operations on multiple threads of the processor causes the multiple operations to be run concurrently,
wherein an operation is a structured set of tasks used to perform a specific computation required to execute the requested process, and
wherein an operation includes multiple dependencies;
analyzing the multiple operations,
wherein analyzing the multiple operations determines a type of operation or dependency of an operation on other operations;
categorizing the multiple operations based on operation type or dependency on other operations;
dividing each operation into at least one task,
wherein an outcome of the at least one task can either be a success or a failure;
generating a queue of tasks,
wherein the queue of tasks contains the tasks for each of the multiple operations,
wherein generating the queue of tasks converts the multiple operations from a multi-threaded process to a single-threaded process, and
wherein the tasks are queued sequentially according to the multiple dependencies;
executing, on a single thread of the processor, the queue of tasks based on the multiple dependencies; and
outputting a result for each task executed in the queue of tasks,
wherein the result represents either a success or a failure of the execution of the at least one task.

16. The method of claim 15 further comprising:
receiving a failed task alert;
analyzing the failed task alert to determine that failure affects at least one other task; and
ending the operation based on the failed task alert when the failure of the execution of the at least one task causes a failure of the operation.

17. The method of claim 15 further comprising:
removing repeated tasks from the queue of tasks.

18. The method of claim 15, wherein executing the queue of tasks authenticates a user, further comprising:
receiving an operation request to authenticate the user;
dividing the operation into multiple tasks,
wherein the multiple tasks include receiving a user credential, validating the user credential, obtaining an authentication token, validating the authentication token, and authenticating the user;
queuing the multiple tasks based on a dependency of the tasks; and
executing the multiple tasks, wherein executing the tasks causes the method to further comprise:
receiving the user credential,
wherein the user credential includes a username or password for the user;
validating the user credential with an authentication server,
wherein a failure to validate the user credential notifies the user of the failure and ends the operation;
obtaining, based on a successful validation of the user credential, the authentication token from the authentication server;
validating the authentication token with a resource server,
wherein a failure to validate the authentication token with the resource server notifies the user of the failure and ends the operation; and
authenticating the user, based on a successful execution of each task.

19. The method of claim 15, wherein executing the queue of tasks causes a user to receive an access token, further comprising:
receiving an operation request to receive the access token,
wherein the access token stores security information and allows the user to access a process or application;
dividing the operation into multiple tasks,
wherein the multiple tasks include receiving a request for the access token, connecting to an authentication server, receiving a time code, receiving the access token, and saving the access token;
queuing the multiple tasks based on a dependency of the tasks; and
executing the multiple tasks, wherein executing the tasks causes the method to further comprise:
receiving the request for the access token from a user device;
determining a connection to the authentication server over a communication network;
receiving a time code from the authentication server,
wherein a failure to validate the time code of the authentication server against the user device ends the operation;
receiving the access token from the authentication server; and
saving the access token to the user device.

20. The method of claim 15 further comprising:
converting the multiple operations coded to run on the multiple threads of the processor to run on the single thread of the processor,
wherein converting the multiple operations to run on the single thread of the processor minimizes race conditions and concurrent modification issues.
